(19) United States
(12) Patent Application Publication
(10) Pub. No.: US 2012/0323806 A1
(43) Pub. Date: Dec. 20, 2012

(54) System and Method for Management of Material Content

(75) Inventors: Zachary W. Abrams, Durham, NC (US); Jacklin A. Adams, Research Triangle Park, NC (US); Louis R. Ferritti, JR., Research Triangle Park, NC (US); Prasad L. Imandi, Durham, NC (US); Angela Richards Jones, Research Triangle Park, NC (US); Kenneth S. Lyjak, Research Triangle Park, NC (US); Sheau Li Ng, Singapore (SG); Fabio D. White, Poughkeepsie, NY (US)

(73) Assignee: INTERNATIONAL BUSINESS MACHINES CORPORATION, Armonk, NY (US)

(21) Appl. No.: 13/163,964

(22) Filed: Jun. 20, 2011

(51) Int. Cl. G06Q 99/00

(52) U.S. Cl. 705/317

(57) ABSTRACT

Embodiments of the invention relate to product and associate product materials, and maintaining compliance with rules and regulations to support interstate and international commerce. As rules and regulations change associated with products and/or raw materials that comprise the product, those changes or messages are monitored and communicated in real-time in order to support continued compliance in the stream of commerce.

### BACKGROUND

1. Technical Field

The present invention relates to a method and system for compliance with legal rules and regulations. More specifically, the invention relates to a system and method that ensures product compliance in real-time.

2. Description of the Prior Art

With the advent of telecommunications, business takes place at an ever growing pace. Entities may places product orders on-line followed by shipment of the product directly to the requesting consuming entity. At the same time, it is known that products offered for sale may be subject to different geographic compliance rules and regulations. For example, in the United States different states have different sales taxes for product sales. The taxes are administered on a state level, as there is no federal sales tax. At the time of product purchase, the consumer is required to pay the sales tax in the state in which the product is being delivered. Accordingly, the sales tax is one example of a law associated with a product sale.

The sales tax described above in one example of a law associated with a product sale. However, there are other forms of rules and regulations associated with product sales, including but not limited to, import and export, regulation of materials, etc. Tracking relevant rules and regulations for one product is difficult; tracking relevant rules and regulations for a plurality of products is even more challenging.

### SUMMARY OF THE INVENTION

This invention comprises a method, system, and apparatus for management of product compliance.

In one aspect of the invention, a computer implemented method is provided for product compliance oversight. More specifically, a server is provided with a data structure to store product data, with the product data including product specification information and product material data. The data structure provides an organization to associate the product with regulation data, and to identify within the data structure regulations in which the product is in compliance and regulations where the product violates compliance. A request is received for verification that the product specification and material data is in compliance with an identified product regulation data. The identified product regulation data is extracted and matched with the product material data. The associated compliance data is dynamically validated with the extracted regulation data.

In another aspect, a system is provided with a server in communication with storage media. A data structure is stored within the storage media and stores the product data including product specification information and product material data. A functional unit is provided in communication with the data structure, with the functional unit to support compliance of the product to associated rules and regulations associated with the product. The functional unit is provided with a regulation manager, a verification manager, an extraction manager, and a validation manager. The regulation manager functions to associate the product with regulation data, including identification within the data structure of regulations in which the product is in compliance and regulations that the product violates compliance. The verification manager is provided in communication with the regulation manager to receive a request for verification that the product specification and material data is in compliance with an identified product regulation data. The extraction manager, which is in communication with the verification manager, extracts the identified product regulation data and to match the extracted regulation data with the product material data. Finally, the validation manager dynamically validates associated compliance data with the extracted regulation data.

In yet another aspect, a computer program product is provided for use with an electronic communication. The computer program product includes a computer-readable storage medium having computer readable program code embodied thereon, which when executed causes a computer to implement a method pertaining to products and regulatory authority. More specifically, the computer program product is for use with a data structure of product specification information and product material data, and an association with product regulation data. The computer program product employs a computer readable storage medium having computer readable program code embodied thereon, which when executed causes a computer to identify within the data structure regulations in which the product is in compliance and regulations that the product violates compliance. In response to receipt of a request for verification that the product specification and material data is in compliance with an identified product regulation data, program code extracts the identified product regulation data and determines if there is a match of the extracted regulation data with the product material data. Program code is provided to either validate or invalidate compliance data with the extracted regulation data in real-time.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawings are meant as illustrative of only some embodiments of the invention, and not of all embodiments of the invention unless otherwise explicitly indicated. Implications to the contrary are otherwise not to be made.

FIG. 1 is a flowchart illustrating a process for maintaining a database of rules and regulations for use with import and export of products.

FIG. 2 is a flow chart illustrating a process for adding a new material to the materials database and how this affects associated rules and regulations.

FIG. 3 is a flow chart illustrating a process for consideration of a new geographic location for import or export of a product.

FIGS. 4A and 4B depicta process for real-time validation of a product and its associated materials with compliance with rules and regulations for the stream of commerce.

FIG. 5 is a flow chart illustrating an overview of the components shown in FIGS. 1-4 to provide a comprehensive view of the process.

FIG. 6 is a block diagram illustrating tools embedded in a computer system for database management and product validation.

FIG. 7 depicts a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional units described in this specification have been labeled as tools, modules, and/or managers. The functional units may be implemented in programmable hardware devices such as field programmable gate arrays, programmable array logic, programmable logic devices, or the like. The functional units may also be implemented in software for execution by various types of processors. An identified functional unit of executable code may, for instance, comprise one or more physical or logical blocks of computer instructions which may, for instance, be organized as an object, procedure, function, or other construct. Nevertheless, the executables of an identified functional unit need not be physically located together, but may comprise disparate instructions stored in different locations which, when joined logically together, comprise the functional unit and achieve the stated purpose of the functional unit.

Indeed, a functional unit of executable code could be a single instruction, or many instructions, and may even be distributed over several different code segments, among different applications, and across several memory devices. Similarly, operational data may be identified and illustrated herein within the functional unit, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of modules, managers, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

In the following description of the embodiments, reference is made to the accompanying drawings that form a part hereof, and which shows by way of illustration the specific embodiment in which the invention may be practiced. It is to be understood that other embodiments may be utilized because structural changes may be made without departing form the scope of the present invention.

Electronic tools are becoming abundantly popular for managing products sales and associated shipping of such products. More specifically, the tools address use of hardware, and the associated hardware material, in commerce. The electronic tools employs data structures, or data bases, in communication with a search engine to maintain the current status of data retained within the data structures. Message based communication is employed to support the current status of the database, as well as real-time validation of specific products or materials associated therewith. The message based communication supports communication via text in place of or supplementary to voice based communication. Real-time validation supports active decision making in a dynamic manner.

Sales of a product are directly related to the material(s) of the product and associated rules and regulations. In other words, in order to sell a product in commerce, the product must abide by any government authorized rules and regulations. This applies to import and export of products. More specifically, there may be a first set of rules and regulations directly related to export of the product(s), and a second set of rules and regulations directly related to import of the product(s). At the same time, what may appear as a single product may be comprised of two or more materials, with each of the materials requiring clearance from associated rules and regulations prior to import or export of the single product.

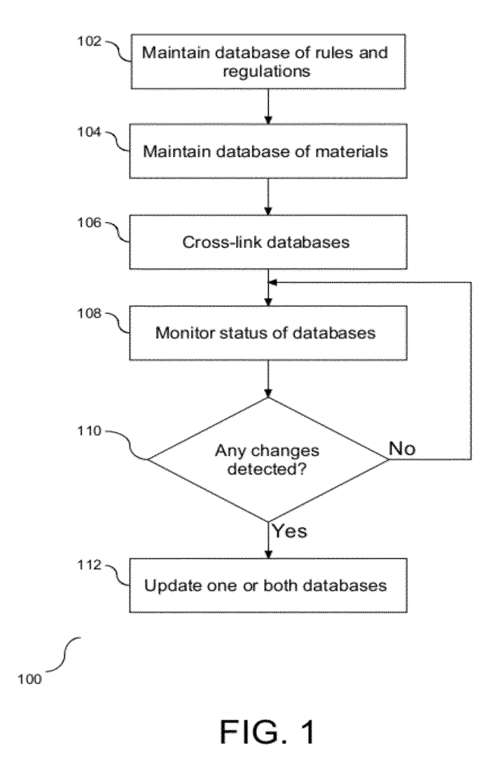

Sales of products drive the economic engine that sustains a commercial enterprise. FIG. 1 is a flowchart (100) illustrating a process for maintaining a database or rules and regulations for use with import and export of products. As shown, a database of extracted rules and regulations is maintained (102). In addition, a database of materials is maintained (104). The two databases are cross-linked so that the rules and regulations may be applied to the materials that comprise one or more products (106). In order to keep the databases of rules and regulations current with the materials database, the status of the databases is monitored (108). In one embodiment, the monitoring of the databases takes place on a periodic basis, which may be based upon set time duration or dynamically configurable time duration. Similarly, in one embodiment, at such time as a rule or regulation is changes, or at such time as a new material is added to the database, the status of the databases is updated. Following step (108), it is determined if any changes to rules and regulations cross-linked to the subject materials has been ascertained (110). A negative response to the determination at step (110) is followed by a return to step (108). Conversely, a positive response to the determination at step (110) is followed by an update of one or more of the databases (112). In addition to updating the database(s), a notification of the updated databases is communicated to each designated party. The update may come in different forms, including but not limited to, electronic mail communication, text based communication, etc. In one embodiment, the update may be communicated to a list of recipients in a single communication. Accordingly, the existing databases are maintained with current data and any change associated with the data maintained in the databases is communicated to designated parties.

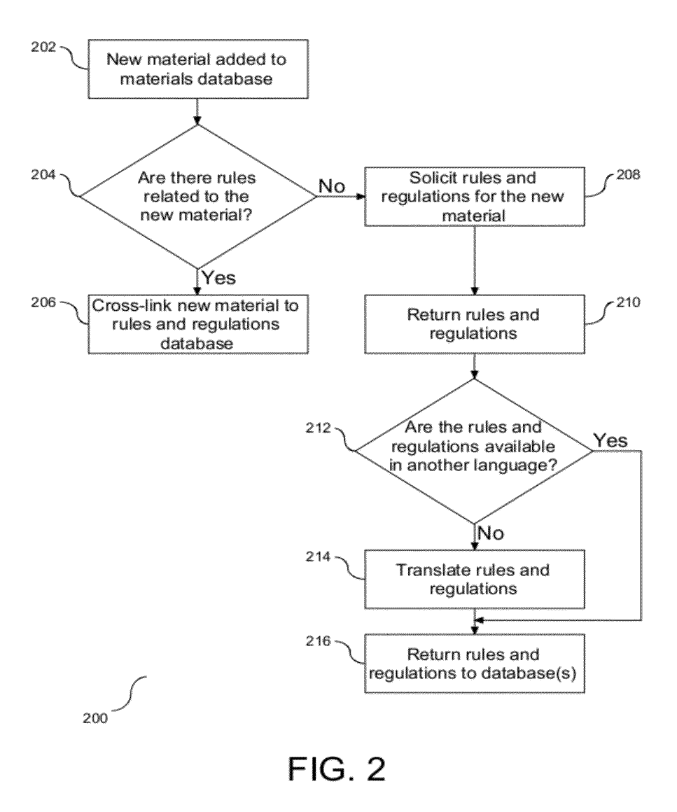

Data maintained in the rules and regulations database may be removed from the databases as rules and regulations are terminated. Similarly, materials associated with products may be removed from the products database as product materials change and the materials in the database are no longer a part of the product. At the same time, new products and their associated material(s) may be added to the materials database. FIG. 2 is a flow chart (200) illustrating a process for adding a new material to the materials database and how this affects associated rules and regulations. After a new material is entered into the materials database (202), it is determined if there are any associated rules and regulations in the rules and regulations database related to the new material (204). A positive response to the determination at step (204) is followed by cross-linking the new material to the rules and regulations in the database (206). Conversely, a negative response to the determination at step (204) is followed by sending a query to a search engine to solicit appropriate rules and regulations for the subject new material (208). Following a return of the rules and regulations (210), it is determined if the rules and regulations are available in a specified language (212). More specifically, rules and regulations may be published in different languages. In one embodiment, a translation tool may be employed to translate the extracted rules and regulations into a language specified by the user. A negative response to the determination at step (212) is followed by a translation of the extracted rules and regulations (214). Following completion of the translation at step (214) or a positive response to the determination at step (212), the extracted rules and regulations are returned to the rules and regulations database (216) following by a return to step (206). Accordingly, as new products and their associated materials are added into the stream of commerce, the rules and regulations are updated and/or cross-linked to the materials database.

As shown in FIGS. 1 and 2, both the materials database and the rules and regulations database are not static. Materials may be added to or removed from the database. As materials are added to the database, associated rules and regulations are updated. In one embodiment, as materials are removed associated rules cross-linked to the product database may be removed. At the same time, new geographic locations for commerce may enter consideration. As a product enters a different geographic jurisdiction, it must be determined if the product is in compliance with the rules and regulations associated with the different jurisdiction.

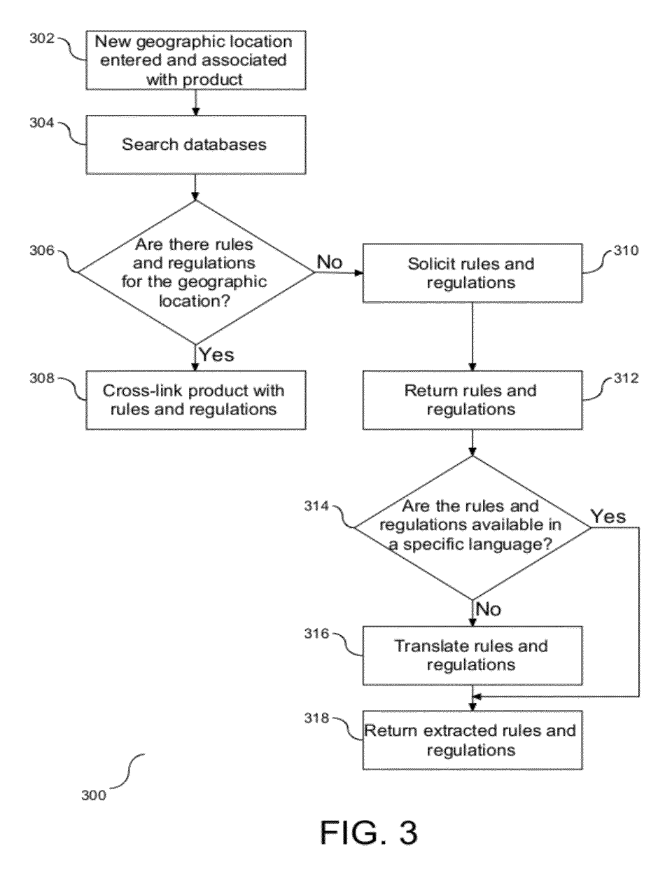

FIG. 3 is a flow chart (300) illustrating a process for consideration of a new geographic location for import or export of a product. As shown, a new geographic location is entered and associated with the product (302). Based upon the entry at step (302), the rules and regulations database is searched (304) to determine if it contains rules and regulations for product materials for the entered geographic location (306). A positive response to the determination at step (306) is followed by cross-linking the product with the rules and regulations (308). Conversely, a negative response to the determination at step (306) is following by sending a query to a search engine to solicit appropriate rules and regulations for the subject material with the new geographic location (310). Following a return of the rules and regulations (312), it is determined if the rules and regulations are available in a specified language (314). More specifically, rules and regulations may be published in different languages. In one embodiment, a translation tool may be employed to translate the extracted rules and regulations into a language specified by the user. A negative response to the determination at step (314) is followed by a translation of the extracted rules and regulations (316). Following completion of the translation at step (316) or a positive response to the determination at step (314), the extracted rules and regulations are returned to the rules and regulations database (318). Accordingly, as new geographic boundaries are crossed for existing products and their associated materials, the rules and regulations are updated and/or cross-linked to the materials database.

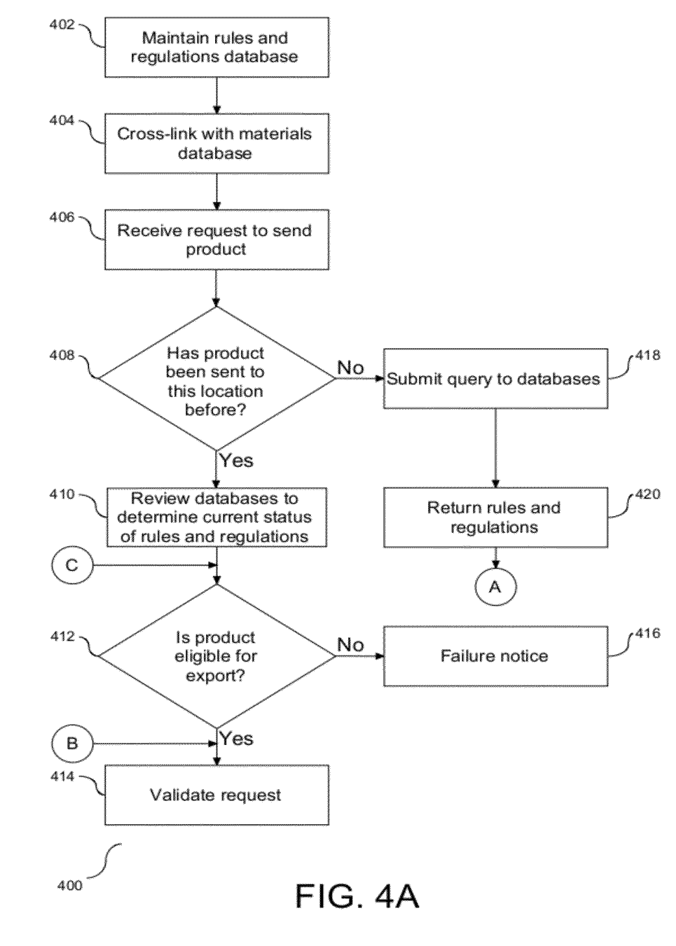

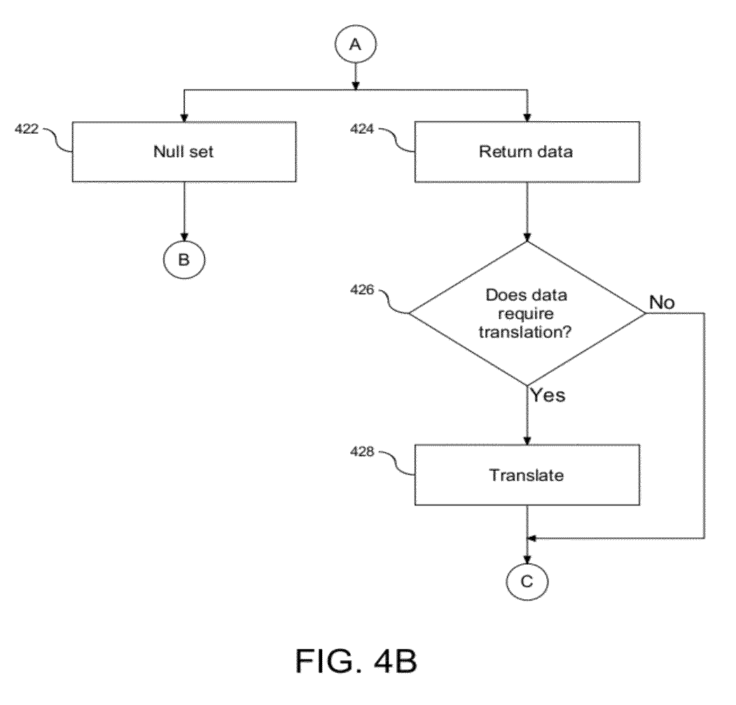

As shown in FIG. 1-3, databases are created, maintained, and updated to keep products in the stream of commerce while in compliance with rules and regulations in the geographic boundaries of commerce. Rules and regulations are dynamic and are subject to change based upon government legislation and rulemaking. At the same time, products are not necessarily static and product lines and associated materials are also subject to change based upon corporate decision making. FIGS. 4A and 4B depict a flow chart (400) illustrating a process for real-time validation of a product and its associated materials with compliance with rules and regulations for the stream of commerce. As explained above, a rules and regulations database is maintained (402) and cross-linked with a product materials database (404). In response to receipt of a request to send a product to a specific geographic location (406), it is determined if the product has previously been sent to the location (408). A positive response to the determination at step (408) is following by a review of the cross-linked databases to determine the current status of the product materials and the associated rules and regulations (410). Following step (410) it is determined if the product is eligible to be send to the requested location (412). A positive response to the determination at step (412) concludes the validation process with a communication sent to the requesting user (414). In one embodiment, the evaluation and communication is conducted in real-time to provide the user with efficient order processing. A negative response to the determination at step (412) is followed by sending a communication indicating the associated failure and a requirement to review product compliance issues with the rules and regulations (416). Accordingly, rules and regulations are reviewed and processed for each shipment or associated purchase order as the rules and regulations are dynamic and the validation accommodates this dynamic property.

A negative response to the determination at step (406) is an indication that the geographic location for the product order is new. To support compliance requirements, a query is submitted to solicit rules and regulations for the subject product and associated materials, as well as the geographic location (418), and rules and regulations are return as a query response (420). In one embodiment, the rules and regulations may return a null set (422) which would support the product order. A null set return is followed by a return to step (414). However, if at least one rule or regulation is returned (424), it is determined if the rules and regulations require translation (426). In one embodiment, as a product enters a new jurisdiction for commerce, the new jurisdiction may be associated with a different language and have the rules and regulations published in a language foreign to the user. A positive response to the determination at step (426) is followed by translation of the returned rules and regulations (428). Following a negative response to the determination at step (426) or following the translation at step (428), the validation process returns to step (412). Accordingly, the real-time validation of the products and its associated materials includes updating the rules and regulations database to accommodate a new jurisdiction for commerce.

As illustrated above, rules and regulations are subject to change based upon government authority, and at the same time product and associated product materials are subject to change based upon corporate authorities. The rules and regulations database, as well as the products and materials database, may be separately or jointly updated to reflect associated changes. In one embodiment, a corporate entity may subscribe to a service to provide updates to rules and regulations. As shown in FIG. 1, the status of rules and regulations may be monitored. With respect to a subscription service, a subscriber receives an automatic notification of an update to a product regulation or to a new product regulation. In one embodiment, the user of the subscription server may refine the service to limit notifications to industry standards and/or company formats. The subscription service may come in different forms. In one embodiment, the user may employ a filter in conjunction with the databases and receipt of associated notifications. The filter(s) enable the user to limit updates and/or notification to select products and/or rules and regulations. For example, the filter may apply to recalled products, rules and regulations associated with a specific chemical, hazardous material, etc. Accordingly, whether by subscription or not, the user may employ a filter in the database(s) to remain current with rules and regulations associated with product and product materials.

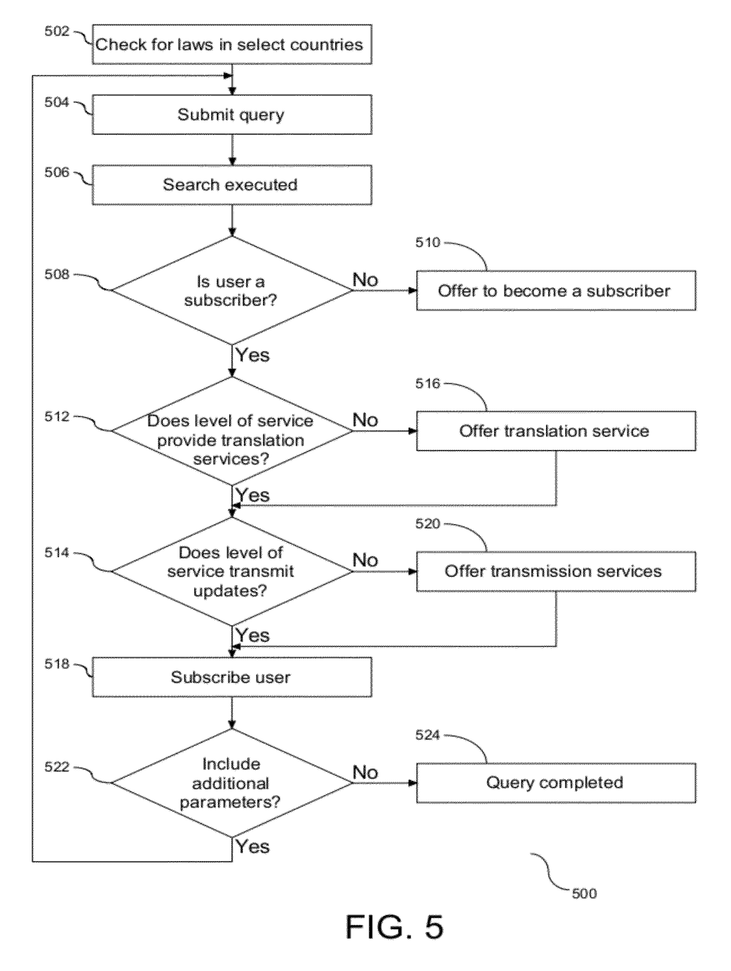

FIGS. 1-4 illustrated above demonstrate the different elements available to support the product validation with rules and regulations for commerce. As is understood, all products are comprised of raw materials, and as such, the product database may be refined to address the specific raw materials, as rules and regulations may be applied directly to the raw material that is within the product. FIG. 5 is a flow chart (500) illustrating an overview of the components shown in FIGS. 1-4 to provide a comprehensive view of the process. As shown, a user logs into a site to check for laws for a select set of countries (502), and based on this selection inputs a query (504). In response to the submission, an engine executes the search based upon the user provided selection (506). Before returning search results to the user, it is determined if the user is a subscriber to the service employing the search engine and associated query (508). A negative response to the determination at step (508) is following by an offer to subscribe to the service, and in one embodiment, different levels of service that may be provided to a subscriber (510). For example, different elements of subscription may support automatic update notifications, language translation, etc. If the user elects to become a subscriber in response to the offer at step (510) or following a positive response to the determination at step (508), it is ascertained if the user (who is a subscriber to the service) has a level of service that provides translation services to a target language (512), and if the level of service does not include translation to offer the service to the subscriber (516). Accordingly, a user who is a subscriber may set the subscription for a specified level of service.

Following step (512), it is determined if the user subscription service includes transmission of a communication when an update to one or more designated rules and regulations has taken place (514). A positive response to the determination at step (514) is followed by subscribing the user to the notification service (518). As described herein, a subscription to an update service pushes relevant data to the user on a periodic basis. Similarly, a negative response to the determination at step (514) is followed by an offer for automated transmission services (520). Following either step (518) or (520), it is determined if the user wants to set the subscription to includes different or additional search parameters (522). A positive response to the determination at step (522) is followed by a return to step (504). Conversely, a negative response is followed by completion of the query and associated results (524); the user may access database to pull data but the user settings do not enable the database to push data to the user. Accordingly, the user may subscribe to different levels of the service, including, but not limited to, automating one or more filters to maintain current product validation data.

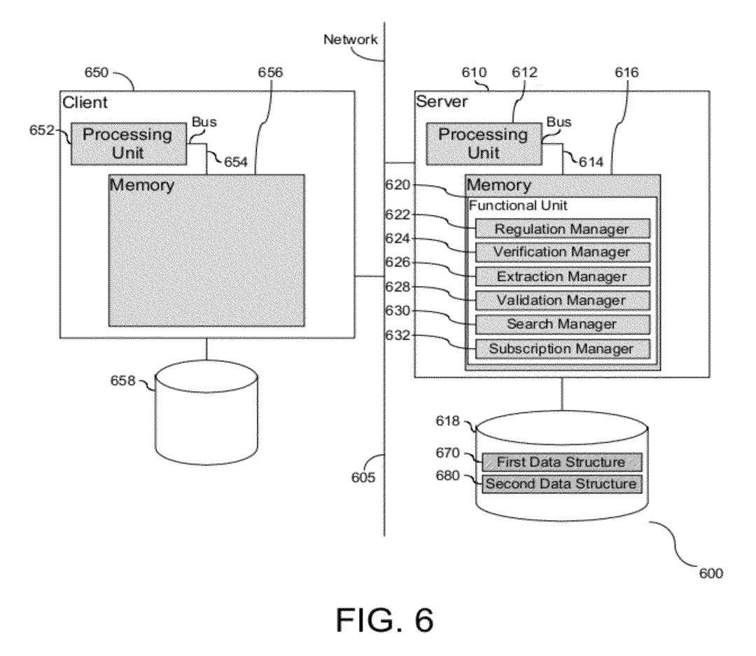

Support for the database management and maintenance, as well as validation of product data may be supported by hardware and/or software tools. FIG. 6 is a block diagram (600) illustrating tools embedded in a computer system to provide database management and product validation. As shown, a computer system is provided with a server (610) in communication with a client machine (650) over a network (605). Although only one server (610) and one client machine (650) are shown herein, in one embodiment additional client machines and/or servers may be provided in communication over the network (605). As shown, the server (610) is provided with a processing unit (612) in communication with memory (616) across a bus (614) and in communication with data storage (618), and client machine (650) is provided with a processing unit (652) in communication with memory (656) across a bus (654) and in communication with data storage (658).

As described above, two data structure are maintained. A first data structure (670) stores product and associated product material data, and a second data structure (680) stores regulatory data, including rules and regulations from different jurisdictions pertaining to products and associated product material. In one embodiment, the first and second data structures (670) and (680) may be in the form of databases. The first and second data structures (670) and (680), respectively, are stored in data storage (618) in communication with the server (610), although in one embodiment, the data structures (670) and (680) may be stored in data storage (658) local to the client machine.

The server (610) is provided with a functional unit (620) in communication with data structures (670) and (680). More specifically, the functional unit (620) includes tools to support product verification and validation, including a regulation manager (622), a verification manager (624), an extraction manager (626), a validation manager (628), a search manager (630), and a subscription manager (632). The regulation manager (622) is responsible for associating a specified product with regulation data. As noted above, the first data structure (670) stores product and product material data. The regulation manager (622) identifies within the first data structure (670) rules and regulations that may be applicable to the specified product. The regulation manager (622) is in communication with a verification manager (624).

Following identification by the regulation manager (622), the verification manager (624) is responsible for verifying that the specified product and/or product materials is in compliance with the regulation data identified by the regulation manager (622). The extraction manager (626), which is in communication with the verification manager (624), extracts the product regulation data identified by the regulation manager (622) and matches the extracted regulation data with the product and/or product material data. Based upon the matching, a validation manager (628) validates the compliance data ascertained by the regulation manager (622) with the regulation data as extracted by the extraction manager (626). The validation manager (628) validates the compliance data in real-time. Accordingly, a set of managers are provided to support product regulation management.

In addition to the regulation, verification, extraction, and validation managers (622)-(628), respectively, a search manager (630) is provided as a member of the functional unit (620). The search manager (630) functions to search for release of new laws, rules, and/or regulations. More specifically, the search manager (630) identifies products and/or product materials in the first data structure (670) to which the new law, rule, and/or regulation applies and creates an association of the new law, rule, and/or regulation with the identified product or product material. As described in FIG. 5, a user may subscribe to a service that sends updating communication on specified products and/or materials with respect to changes in law, rules, and/or regulations. In one embodiment, the first data structure (670) may include a list of subscribers and their associated product and/or product material interest. The search manager (630) may send an electronic communication (not shown) to one or more members of the list in response to an update. With respect to a subscription service, the electronic communication is automated each time a relevant new or updated law, rule, or regulation is identified. In one embodiment, a subscription manager (632) is provided in communication with the search manager (630), with the subscription manager responsible for refining the subscription service to notify a subscriber of industry standard data and/or company defined format data. Accordingly, the subscription manager (632) is responsible for maintaining subscription services between the user and the databases.

In one embodiment, the databases may be employed for regulatory data on interstate commerce as well as international commerce. However, with respect to international commerce, rules and regulations may come in different languages. As such, the search manager (630) is configured to associate a geographical location of the product and/or product material with regulatory data. In addition, the search manager (630) identifies the language of the geographical location and ensures communication of product regulation data in the identified language. More specifically, if a translation is required, the search manager (630) ensures that the translation takes place so that the product regulation is communicated to a user in a designated language. Accordingly, foreign languages are made transparent by identifying and supporting translation of rules and regulation.

As shown herein, the managers (622)-(632) of the functional unit (620) are provided local to the server (610), and more specifically, residing in memory (616) of the server (610). In one embodiment, the managers may reside as hardware tools external to memory (616), or they may be implemented as a combination of hardware and software. Similarly, in one embodiment, the managers may be combined into a single functional item that incorporates the functionality of the separate items. As shown herein, each of the manager(s) is shown local to one data site. However, in one embodiment they may be collectively or individually distributed across a shared pool of configurable computer resources and function as a unit to manage creation of identical consistency points in two different file systems. Accordingly, the managers may be implemented as software tools, hardware tools, or a combination of software and hardware tools.

As will be appreciated by one skilled in the art, aspects of the present invention may be embodied as a system, method or computer program product. Accordingly, aspects of the present invention may take the form of an entirely hardware based embodiment, an entirely software based embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

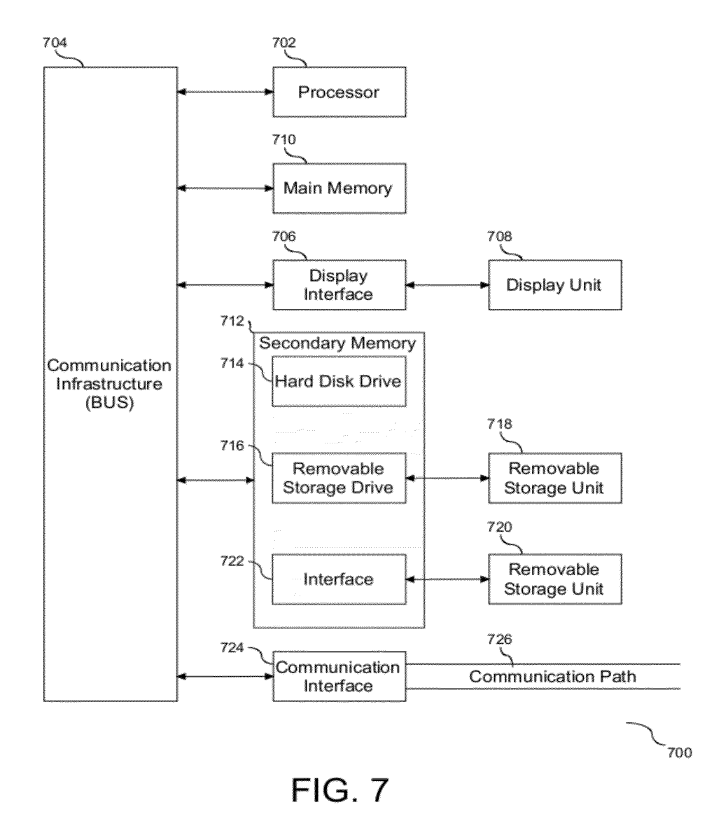

Referring now to the block diagram of FIG. 7, additional details are now described with respect to implementing an embodiment of the present invention. The computer system includes one or more processors, such as a processor (702). The processor (702) is connected to a communication infrastructure (704) (e.g., a communications bus, cross-over bar, or network).

The computer system can include a display interface (706) that forwards graphics, text, and other data from the communication infrastructure (704) (or from a frame buffer not shown) for display on a display unit (708). The computer system also includes a main memory (710), preferably random access memory (RAM), and may also include a secondary memory (712). The secondary memory (712) may include, for example, a hard disk drive (714) and/or a removable storage drive (716), representing, for example, a floppy disk drive, a magnetic tape drive, or an optical disk drive. The removable storage drive (716) reads from and/or writes to a removable storage unit (718) in a manner well known to those having ordinary skill in the art. Removable storage unit (718) represents, for example, a floppy disk, a compact disc, a magnetic tape, or an optical disk, etc., which is read by and written to by removable storage drive (716). As will be appreciated, the removable storage unit (718) includes a computer readable medium having stored therein computer software and/or data.

In alternative embodiments, the secondary memory (712) may include other similar means for allowing computer programs or other instructions to be loaded into the computer system. Such means may include, for example, a removable storage unit (720) and an interface (722). Examples of such means may include a program package and package interface (such as that found in video game devices), a removable memory chip (such as an EPROM, or PROM) and associated socket, and other removable storage units (720) and interfaces (722) which allow software and data to be transferred from the removable storage unit (720) to the computer system.

The computer system may also include a communications interface (724). Communications interface (724) allows software and data to be transferred between the computer system and external devices. Examples of communications interface (724) may include a modem, a network interface (such as an Ethernet card), a communications port, or a PCMCIA slot and card, etc. Software and data transferred via communications interface (724) are in the form of signals which may be, for example, electronic, electromagnetic, optical, or other signals capable of being received by communications interface (724). These signals are provided to communications interface (724) via a communications path (i.e., channel) (726). This communications path (726) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (710) and secondary memory (712), removable storage drive (716), and a hard disk installed in hard disk drive (714).

Computer programs (also called computer control logic) are stored in main memory (710) and/or secondary memory (712). Computer programs may also be received via a communication interface (724). Such computer programs, when run, enable the computer system to perform the features of the present invention as discussed herein. In particular, the computer programs, when run, enable the processor (702) to perform the features of the computer system. Accordingly, such computer programs represent controllers of the computer system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed.

Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### Alternative Embodiment

It will be appreciated that, although specific embodiments of the invention have been described herein for purposes of illustration, various modifications may be made without departing from the spirit and scope of the invention. In particular, the system can be configured to manage a product in commerce with respect to compliance standards. The product is managed as an entirety and linked to a hardware portfolio so that either or both of the compliance standards and rule and regulations addresses product materials, components, sub-components, etc. Accordingly, the scope of protection of this invention is limited only by the following claims and their equivalents.

We claim:

1. A computer implemented method comprising:
providing a server with a data structure to store product data, the product data including product specification information and product material data, and associating the product with regulation data, including identifying within the data structure regulations in which the product is in compliance and regulations that the product violates compliance;
receiving a request for verification that the product specification and material data is in compliance with an identified product regulation data;
extracting the identified product regulation data and matching the extracted regulation data with the product material data; and
dynamically validating associated compliance data with the extracted regulation data.

2. The method of claim 1, further searching for release of a new law, including identifying any product in the data structure to which the new law applies and associating the new law with the identified product in the data structure.

3. The method of claim 2, further comprising sending an electronic communication, including the new law, to a pre-defined list of addresses identified in the data structure with the identified product.

4. The method of claim 1, further comprising a subscription service to the data structure, including subscribers to the service receiving automatic notification of an item selected from the group consisting of: an update to the product regulation data, and a new product regulation.

5. The method of claim 4, further comprising refining the subscription service to the data structure, including limiting notification to an item selected from the group consisting of: industry standard data, company defined format data, and combinations thereof.

6. The method of claim 1, further comprising associating a geographical location of the product with the product regulation data, including identifying a language of the geographical location and communicating the product regulation data in the identified language.

7. A system comprising:
a server in communication with storage media, and a data structure within the storage media to store product data, the product data including product specification information and product material data, and a functional unit in communication with the data structure, the functional unit comprising:
a regulation manager in communication with the data structure, the regulation manager to associate the product with regulation data, including identification within the data structure of regulations in which the product is in compliance and regulations that the product violates compliance;
a verification manager in communication with the regulation manager, the verification manager to receive a request for verification that the product specification and material data is in compliance with an identified product regulation data;
an extraction manager in communication with the verification manager, the extraction manager to extract the identified product regulation data and to match the extracted regulation data with the product material data; and
a validation manager to dynamically validate associated compliance data with the extracted regulation data.

8. The system of claim 7, further comprising a search manager to search for release of a new law, including identification by the search manager of any product in the data structure to which the new law applies and creation of an association of the new law with the identified product in the data structure.

9. The system of claim 8, further comprising a send of an electronic communication, including the new law, to a pre-defined list of addresses identified in the data structure with the identified product.

10. The system of claim 7, further comprising a subscription service to the data structure, including receipt of an automatic notification to subscribers of the service, the notification including an item selected from the group consisting of: an update to the product regulation data, and a new product regulation.

11. The system of claim 10, further comprising a subscription manager in communication with the data structure, the subscription manager to refine the subscription service to the data structure, including limiting notification to an item selected from the group consisting of: industry standard data, company defined format data, and combinations thereof.

12. The system of claim 7, further comprising the search manager to associate a geographical location of the product with the product regulation data, including identification of a language of the geographical location, and communication of the product regulation data in the identified language.

13. A computer program product for use with a data structure of product specification information and product material data, and an association with product regulation data, the computer program product comprising a computer readable storage medium having computer readable program code embodied thereon, which when executed causes a computer to implement the method comprising:
identifying within the data structure regulations in which the product is in compliance and regulations that the product violates compliance;
receiving a request for verification that the product specification and material data is in compliance with an identified product regulation data;
extracting the identified product regulation data and matching the extracted regulation data with the product material data; and
validating associated compliance data with the extracted regulation data.

14. The computer program product of claim 13 further searching for release of a new law, including identifying any product in the data structure to which the new law applies and associating the new law with the identified product in the data structure.

15. The computer program product of claim 14, further comprising sending an electronic communication, including the new law, to a pre-defined list of addresses identified in the data structure with the identified product.

16. The computer program product of claim 13, further comprising a subscription service to the data structure, including subscribers to the service receiving automatic notification of an item selected from the group consisting of: an update to the product regulation data, and a new product regulation.

17. The computer program product of claim 16, further comprising refining the subscription service to the data structure, including limiting notification to an item selected from the group consisting of: industry standard data, company defined format data, and combinations thereof.

18. The computer program product of claim 13, further comprising associating a geographical location of the product with the product regulation data, including identifying a language of the geographical location and communicating the product regulation data in the identified language.
